(19) United States
(12) Patent Application Publication
(10) Pub. No.: US 2009/0041419 A1
(43) Pub. Date: Feb. 12, 2009

(54) OPTICAL DISC REPRODUCTION APPARATUS AND METHOD OF CONTROLLING OPTICAL DISC REPRODUCTION APPARATUS

(75) Inventor: Yukihiro Kurita, Kokubunji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/180,100

(22) Filed: Jul. 25, 2008

(30) Foreign Application Priority Data
Aug. 10, 2007 (JP) 2007-209771

(51) Int. Cl. H04N 5/91; G11B 5/09

(52) U.S. Cl. 386/46; 369/47.1; 715/719; G9B/5.033; 386/E05.001

(57) ABSTRACT

According to one embodiment, a method of controlling an optical disc reproduction apparatus for reproducing an optical disc, the method includes displaying the reproducing image of the content on a display, determining if the data put into a data input form in the reproducing image of the content by the user is to be transmitted to a server by way of a network or not, determining if the data is to be transmitted in clear text or not when the data is determined to be transmitted to the server, displaying a selection window containing a button for asking the user to select transmission or non-transmission of the data on the display when the data is determined to be transmitted in clear text, and transmitting the data to the server when the user selects transmission, and not transmitting the data to the server when the user selects non-transmission.

### CROSS-REFERENCE TO RELATED APPLICATIONS

This application is based upon and claims the benefit of priority from Japanese Patent Application No. 2007-209771, filed Aug. 10, 2007, the entire contents of which are incorporated herein by reference.

### BACKGROUND

1. Field

One embodiment of the present invention relates to an optical disc reproduction apparatus that can transmit the data input by the user by way of a network and also to a method of controlling such an optical disc reproduction apparatus.

2. Description of the Related Art

Disc reproduction apparatus for reproducing HD DVD® or Blu-ray disc® that are generally referred to as the next generation DVD have a function of connecting themselves to a network. Network functions typically include a function with which the user transmits credit card information to a server and receives from the server an unlock key that enables the locked part of a set of content to be reproduced.

Meanwhile, when the user transmits credit card information to a server, he or she does not know at all if the credit card information is encrypted or not.

For instance, the web browser that a personal computer executes indicates that the connection of the personal computer is secure typically by means of a key mark (“(7) Where is the key mark for seeing SSL compatibility? [Internet Explorer 7 changeover guide]”, [online], Nov. 22, 2006, Nikkei PC Online, retrieved on Aug. 8, 2007, Internet <URL: http://pc.nikkeibp.co.jp/article/NPC/20061120/254288/>)

Thus, reproduction apparatus for the next generation discs have a problem that if the data input by the user for transmission is not encrypted, they cannot notify the user of the fact.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic perspective view of an optical disc reproduction apparatus according to an embodiment of the present invention, showing the appearance thereof;

FIG. 2 is an exemplary schematic block diagram of the optical disc reproduction apparatus of FIG. 1, showing the system configuration thereof;

FIG. 3 is an exemplary schematic block diagram of the arrangement of the embodiment of the present invention for reproducing an optical disc;

FIG. 4 is an exemplary schematic illustration of an LCD displaying a content window, a control window and a selection window;

FIG. 5 is detailed illustration of the selection window of FIG. 4;

FIG. 6 is an exemplary flowchart showing the sequence of an operation of transmitting the data described in a form;

FIG. 7 is an exemplary flowchart showing the sequence of an operation of transmitting the data described in a form; and

FIG. 8 is an exemplary schematic illustration of the mark being displayed in the control window of an LCD.

### DETAILED DESCRIPTION

Various embodiments according to the invention will be described hereinafter with reference to the accompanying drawings. In general, according to one embodiment of the invention, a method of controlling an optical disc reproduction apparatus for reproducing an optical disc storing information including content, the method comprising, displaying the reproducing image of the content on a display, determining if the data put into a data input form in the reproducing image of the content by the user is to be transmitted to a server by way of a network or not, determining if the data is to be transmitted in clear text or not when the data is determined to be transmitted to the server, displaying a selection window containing a button for asking the user to select transmission or non-transmission of the data on the display when the data is determined to be transmitted in clear text, and transmitting the data to the server when the user selects transmission; and not transmitting the data to the server when the user selects non-transmission.

Now, the present invention will be described in greater detail by referring to the accompanying drawings that illustrate a preferred embodiment of the invention.

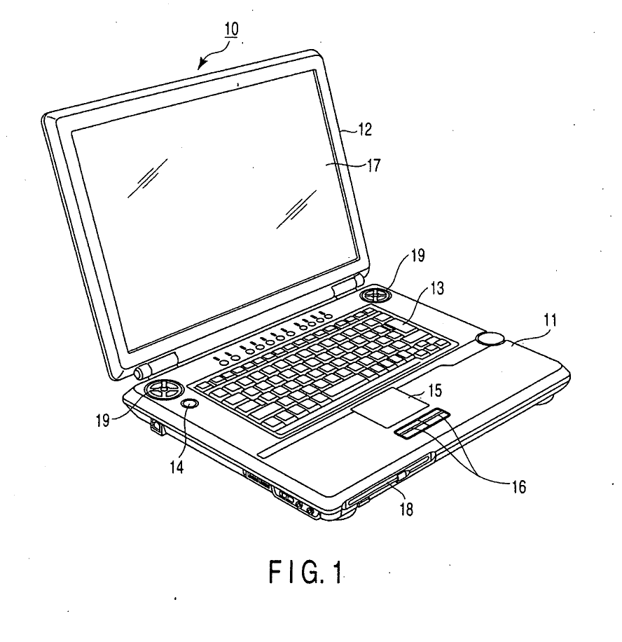

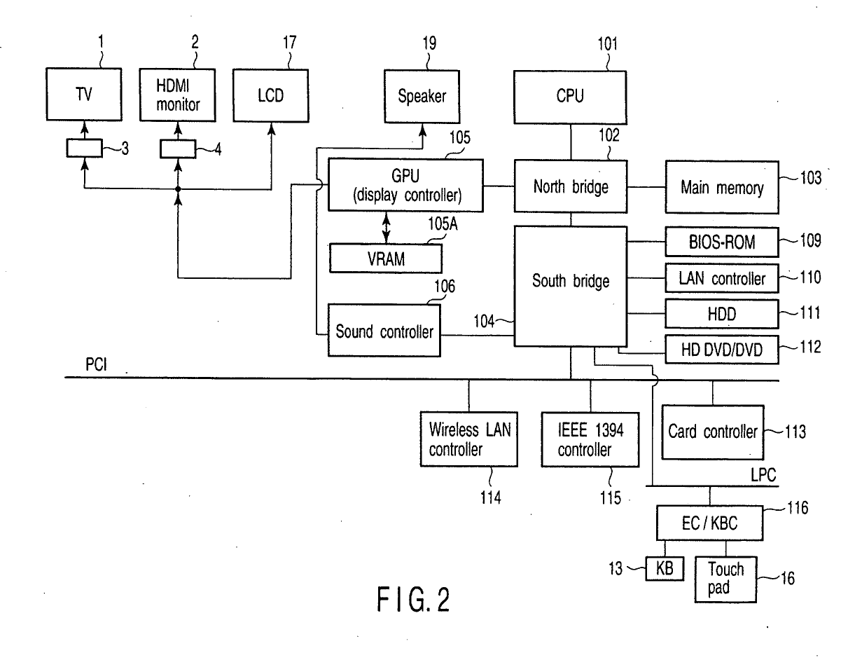

Firstly, the configuration of an information processing apparatus that can operate as an optical disc reproduction apparatus according to a one embodiment of the present invention will be described by referring to FIGS. 1 and 2. The information processing apparatus is typically realized as a notebook type personal computer 10. The notebook type personal computer 10 can reproduce an HD DVDS, which is an optical disc.

FIG. 1 is a schematic perspective view of the notebook type personal computer 10 with the display unit thereof in an open state. The computer 10 includes a computer main body 11 and a display unit 12. The display unit 12 has a display device that is a TFT-LCD (thin film transistor liquid crystal display) 17. The display screen of the LCD 17 occupies a major central part of the display unit 12.

The display unit 12 is fitted to the computer main body 11 such that it can swing between an open position and a closed position relative to the computer main body 11. The computer main body 11 has a thin box-shaped cabinet. A keyboard 13, a power button 14 for turning on/off the computer 10, a touch pad 15, a touch pad control button 16 and a speaker 19 are arranged on the top surface of the cabinet.

Now, the system configuration of the computer 10 will be described below by referring to FIG. 2.

As shown in FIG. 2, the computer 10 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disc drive (HDD) 111, a high definition digital versatile disc (HD DVD)/DVD drive (ODD) 112, a card controller 113, a wireless LAN controller 114, an IEEE 1394 controller 115, an embedded controller/keyboard controller IC (EC/KBC) 116 and a digital TV tuner 117.

The CPU 101 is a processor that controls the operation of the computer 10 and executes the operating system and various application programs that are loaded into the main memory 103 from the hard disc drive (HDD) 111. The CPU 101 also executes the BIOS (basic input output system) stored in the BIOS-ROM 109. The BIOS is a program for controlling hardware.

The north bridge 102 is a bridge device for connecting the local bus of the CPU 101 and the south bridge 104. The north bridge 102 contains a memory controller for accessing/controlling the main memory 103. The north bridge 102 has a function of communicating with the GPU 105 by way of a serial bus conforming to the PCI EXPRESS Standard.

The GPU 105 is a display controller for controlling the LCD 17 that operates as display monitor of the computer 10. The display signal generated by the GPU 105 is transmitted to the LCD 17. The display signal can also be transmitted to external TV1 and/or external HDMI monitor by way of interfaces 3 and/or 4 respectively.

The south bridge 104 controls the devices on the LPC (low pin count) bus and the devices on the PCI (peripheral component interconnect) bus. Additionally, the south bridge 104 contains an IDE (integrated drive electronics) controller for controlling the HDD 111 and the ODD 112. Still additionally, the south bridge 104 has a function of executing communications with the sound controller 106.

The sound controller 106 is a sound source device that outputs the audio data to be reproduced to the speaker 19.

The card controller 113 controls cards such as PC cards and SD (secure digital) cards. The wireless LAN controller 114 is a wireless communication device for executing wireless communications typically conforming to the IEEE 802.11 Standard. The IEEE 1394 controller 115 executes communications with external devices by way of a serial bus conforming to the IEEE 1394 Standard. The embedded controller/keyboard controller IC (EC/KBC) 116 is a 1-chip microcomputer where an embedded controller for power management and a keyboard controller for controlling the keyboard (KB) 13 and the touch pad 15 are integrated. The embedded controller/keyboard controller IC (EC/KBC) 116 has a function of turning on/off the computer 10 according to the user's operation of the power button 14.

The content recorded on the HD DVD that is loaded on the ODD 112 may be of any of a plurality of types. Now, the types of content that can be recorded on an HD DVD will be described below.

Two types of content are defined in the following description. One is standard content and the other is advanced content. A set of standard content is formed by navigation data and a video object on the disc. It is an extension of the 1.1 Version of the DVD-video Standard.

On the other hand, a set of advanced content is formed by advanced navigation data such as a playlist, a markup or a script file, advanced data such as a primary/secondary video set and advanced elements (video, audio and text). At least a play list file and a primary video set have to be positioned on a disc for a set of advanced content, while other data may be arranged on the disc or taken in from a server.

A network can be utilized for advanced content. Several examples include on-line shopping linked with the cinema (content), providing of trailers for new movies, providing of new dubbing languages, providing of audio and video commentaries, control of server behaviors by means of disc-specific IDs, download of the latest trailers and promotion videos, download of unlock key and download of promotion videos and images with limited periods.

The user may be required to fill a form with a combination of the card number of his or her credit card, credit card information such as the expiration date of the card, the user ID and the password and to send the form to a server. The combination of credit card information, the user ID and the password will be collectively referred to as personal information hereinafter.

The disinterested party cannot look into credit card information and personal information with communications using an SSL (secure sockets layer) (including TLS (transport layer security) such as HTTPS protocol. However, the disinterested party can easily look into personal information when the communication path does not employ any SSL such as HTTP (hypertext transfer protocol).

It depends on the intention of the content provider if SSL is employed for communications or not. In the case of web browsers, there are some that show the use of SSL for communications. However, web browsers mostly do not show the use of SSL for communications. Therefore, there is no way for the user to find out if the communication he or she is doing is safe because SSL is employed or not when transmitting personal information.

The data that are put into a form is not necessarily personal information but can be a password shown on a magazine. Then, the user may think that the data put into the form may be transmitted in clear text.

When the optical disc player of this embodiment transmits personal information to a server, it determines if the data to be transmitted is put into a form for communications using SSL or not and asks the user if he or she acknowledges the transmission of the data when the current communication does not use SSL. Thus, this embodiment provides an advantage of protecting personal information of the user.

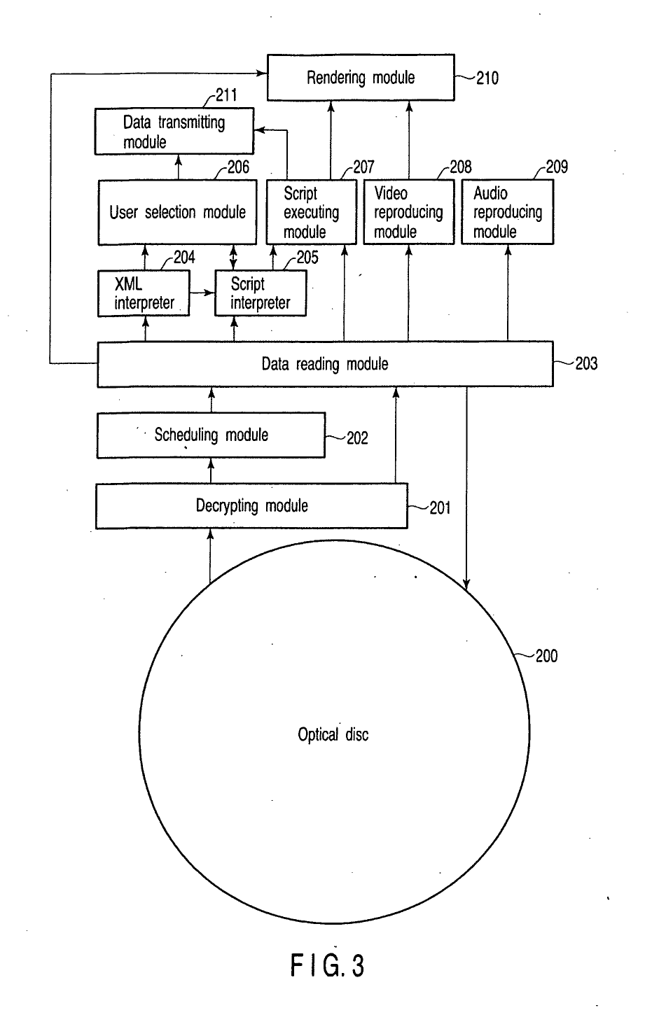

Now, the configuration of the optical disc player that can be realized by the computer 10 that operates as optical disc reproduction apparatus will be described below by referring to FIG. 3. The optical disc player can be realized by a program to be executed by the CPU 101.

This player has a decrypting module 201, a scheduling module 202, a data reading module 203, an XML interpreter 204, a script interpreter 205, a user selection module 206, a script executing module 207, a video reproducing module 208, an audio reproducing module 209, a rendering module 210 and a data transmitting module 211. Note that the decrypting module 201, the scheduling module 202, the data reading module 203, the XML interpreter 204, the script interpreter 205, the user selection module 206, the script executing module 207, the video reproducing module 208, the audio reproducing module 209, the rendering module 210 and the data transmitting module 211 can be realized by a program to be executed by the CPU 101.

Firstly, the decrypting module 201 decrypts the data that is encrypted by means of the AACS system and stored in the optical disc 200. The scheduling module 202 reads out the play list described in XML and performs a scheduling operation of determining the timing of calling out the data from the optical disc 200 and the timings of executing various application programs.

The data reading module 203 calls out the data from the optical disc 200 and issues directives for executing the application programs to the script executing module 207 according to the schedule prepared by the scheduling module 202. The data reading module 203 also issues rendering directives according to the video arrangement described in XML to the rendering module 210. The video reproducing module 208 expands video data and sends the uncompressed video data to the rendering module 210. The audio reproducing module 209 expands audio data and sends them to the sounder controller 106.

The rendering module 210 performs rendering operations according to the video arrangement information described in XML and transmitted from the data reading module 203.

The XML interpreter 204 hooks the video arrangement information sent from the data reading module 203 to the rendering module 210 and determines if there is a form into which the user can input data or not. For example, the XML interpreter 204 can determine if there is a form or not by retrieving the presence or absence of a tag of “<FORM>-</FORM>”. When the XML interpreter 204 determines that there is a form and the user operates the button for transmitting data, the XML interpreter 204 then determines if the tag including a URL for transmitting the data is described in the video arrangement information or not. The information for transmitting data is described either in the tag or in the script that is executed when the transmission button is operated.

The tag for transmitting data is described as <FORM ACTION=“URL” METHOD=POST>, for example. When it is determined that there is a tag for transmitting data, it is then determined if the data described in the form is to be transmitted by means of the protocol for encrypting data or not. If it is determined that the protocol for encrypting data is employed, the data described in the form is transmitted when the user operates the button for transmitting data.

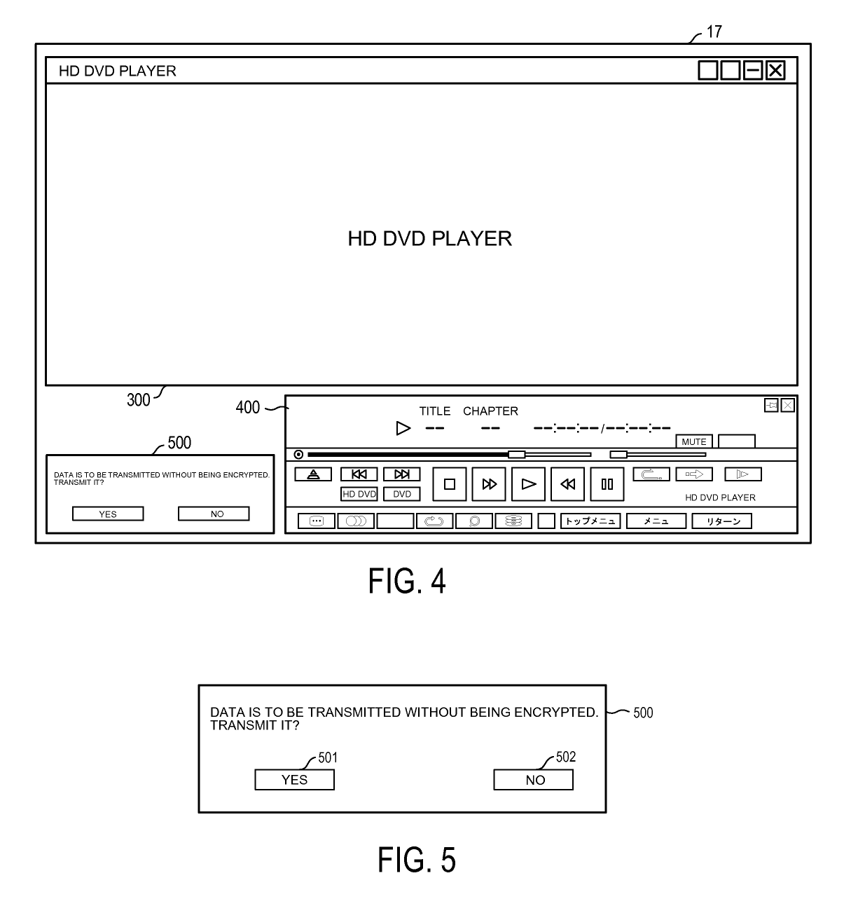

When it is determined that the data are to be transmitted by means of a protocol for not encrypting data and hence written in clear text, the user selection module 206 is notified of the fact. Then, as the user operates the button for transmitting data, the user selection module 206 displays selection window 500 as shown in FIG. 4 on the LCD 17 for asking the user if the data is to be transmitted or not. The selection window 500 shows a “YES” button 501 and a “NO” button 502 as shown in FIG. 5. The user selection module 206 displays the selection window 500 in addition to a content window 300 for reproducing a video of content and a control window 400 for controlling the reproduction of content as shown in FIG. 4. The selection window 500 may be superimposed on the control window 400.

When the user operates the “YES” button 501 and hence makes a decision of transmitting the data, the data transmitting module 211 is given a directive for transmitting the data to the server. When, on the other hand, the user operates the “NO” button 502 and hence makes a decision of not transmitting the data, the data transmitting module 211 is given a directive for not transmitting the data to the server.

When it is determined that the tag including a URL for transmitting data is not described in the video arrangement information, the XML interpreter 204 notifies the script interpreter 205 of the fact. As pointed out above, when the information for transmitting the data is not described in the tag, the information is described in the script that is to be executed when the transmission button is operated. The script stored in the optical disc 200 is encrypted. Therefore, the script is not decrypted until the transmission button is operated.

As the user operates the transmission button and the script is decrypted by the decrypting module 201, the script interpreter 205 snatches the script being delivered from the data reading module 203 to the script executing module 207. The script interpreter 205 analyzes the content of the script and detects the protocol for transmitting the data. Then, the script interpreter 205 determines if the detected protocol is a protocol for encrypting data and hence the data described in the form can be transmitted by means of the protocol or not. When the script interpreter 205 determines that the protocol is a protocol for encrypting data, the script interpreter 205 delivers the script to the script executing module 207. Then, the script executing module 207 executes the script and transmits the data described in the form by way of the data transmitting module 211.

When, on the other hand, the script interpreter 205 determines that the protocol is not a protocol for encrypting data and the data can be transmitted in clear text, the script interpreter 205 notifies the user selection module 206 of the fact. As the user operates the button for transmitting data, the user selection module 206 displays a selection window for asking the user if the data is to be transmitted or not. The selection window 500 shows a “YES” button 501 and a “NO” button 502. The user selection module 206 displays the selection window in addition to a content window 300 for reproducing a video of content.

When the user operates the “YES” button 501 and hence makes a decision of transmitting the data and the script interpreter 205 determines the protocol as a protocol for encrypting data, the script is delivered to the script executing module 207. Then, the script executing module 207 executes the script and transmits the data described in the form by way of the data transmitting module 211. When, on the other hand, the user operates the “NO” button 502 and hence does not authorize to transmit the data, the script is abandoned and hence not transmitted.

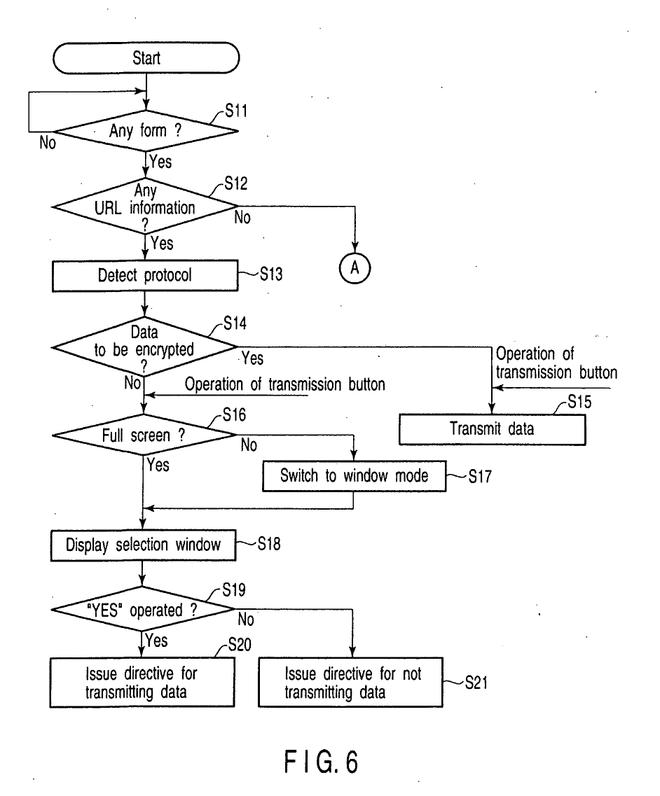

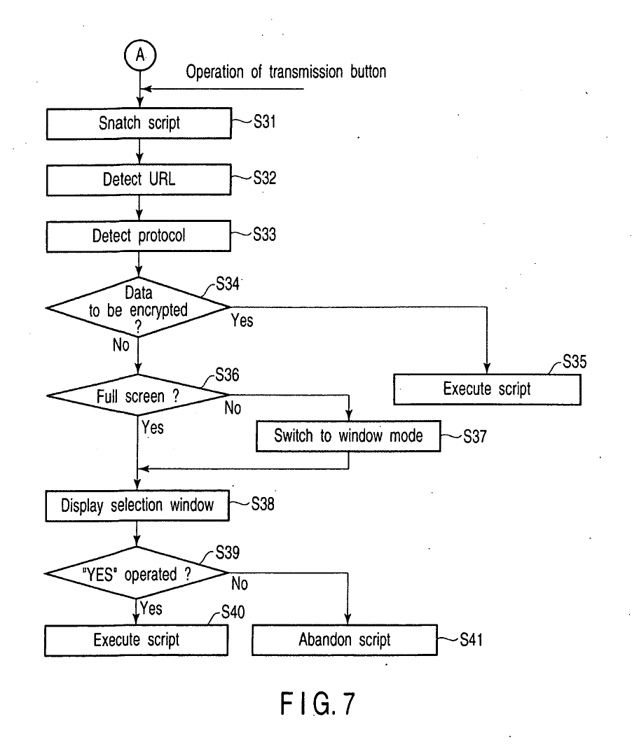

Now, the sequence of transmitting data of the embodiment will be described by referring to FIG. 6.

The XML interpreter 204 hooks the layout information described in XML and transmitted from the data reading module 203 to the rendering module 210 and interprets the XML statement to determine if there is a form or not (Step S11). When the XML interpreter 204 determines that there is a form (Step S11: Yes), the XML interpreter 204 then determines if the XML statement it hooked contains a tag including URL information for transmitting the data in the form or not (Step S12).

When the XML interpreter 204 determines that there is a tag including URL information (Step 12: Yes), the XML interpreter 204 then extracts the URL and the protocol for transmitting the data in the form (Step S13). Then, the XML interpreter 204 determines if the extracted protocol is a protocol for encrypting and transmitting data or not (Step S14).

When the XML interpreter 204 determines that the data is to be encrypted (Step S14: Yes), the XML interpreter 204 does not do anything and, as the user operates the transmission button, the data transmitting module 211 transmits the data in the form (Step S15).

When, on the other hand, the XML interpreter 204 determines that the data is not to be encrypted (Step S14: No), the XML interpreter 204 notifies the user selection module 206 of the fact. As the user operates the transmission button, the user selection module 206 determines if a full screen mode is selected or not (Step S16). When it is determined that a full screen mode is selected (Step S16: Yes), the user selection module 206 issues a directive for switching to the window mode to the rendering module 210 (Step S17).

When, on the other hand, it is determined in Step S16 that a full screen mode is not selected (Step S16: No), the user selection module 206 displays a selection window for asking the user if the data is to be transmitted or not (Step S18). The selection window 500 shows a “YES” button 501 and a “NO” button 502. The user selection module 206 displays the selection window in addition to a content window 300 for reproducing a video of content.

As the user operates either the “YES” button 501 or the “NO” button 502, the user selection module 206 determines if the button that the user operates is the “YES” button 501 or not (Step S19).

When the user selection module 206 determines that the button that the user operates is the “YES” button 501 (Step S19: Yes), the user selection module 206 issues a directive for transmitting the data to the server to the data transmitting module 211 (Step S20). When, on the other hand, the user selection module 206 determines that the button that the user operates is not the “YES” button 501 (Step S19: No), the user selection module 206 issues a directive for not transmitting the data to the server to the data transmitting module 211 (Step S21).

The sequence of operation to be followed when it is determined in Step S12 that there is no URL information (Step S12: No) will be described below. As the user operates the transmission button, the script interpreter 205 snatches the decrypted script being delivered from the data reading module 203 to the script executing module 207 (Step S31). The script interpreter 205 does not deliver the script to the script executing module 207.

The script interpreter 205 detects the URL of the server to which the data in the form is to be transmitted from the script it snatched (Step S32) Then, the script interpreter 205 detects the protocol for transmitting the data in the form from the detected URL (Step S33). The script interpreter 205 then determines if the detected protocol is a protocol for encrypting and transmitting data or not (Step S34).

When the script interpreter 205 determines that the data is to be encrypted (Step S34: Yes), it delivers the script the script interpreter 205 snatched to the script executing module 207 to have the script executed (Step S35). The data in the form is transmitted from the data transmitting module 211 as the script is executed.

When, on the other hand, the script interpreter 205 determines that the data is not to be encrypted (Step S34: No), the script interpreter 205 notifies the user selection module 206 of the fact. Then, the user selection module 206 determines if a full screen mode is selected or not (Step S36). When it is determined that a full screen mode is selected (Step S36: Yes), the user selection module 206 issues a directive for switching to the window mode to the rendering module 210 (Step S37).

When, on the other hand, it is determined in Step S36 that a full screen mode is not selected (Step S36: No), or after the window mode is selected, the user selection module 206 displays a selection window for asking the user if the data is to be transmitted or not (Step S38). The selection window 500 shows a “YES” button 501 and a “NO” button 502. The user selection module 206 displays the selection window 500 in addition to a content window 300 for reproducing a video of content.

As the user operates either the “YES” button 501 or the “NO” button 502, the user selection module 206 determines if the button that the user operates is the “YES” button 501 or not (Step S39).

When the user selection module 206 determines that the button that the user operates is the “YES” button 501 (Step S39: Yes), the user selection module 206 issues a directive for delivering the script snatched by the script interpreter 205 to the script executing module 207. Then, the script interpreter 205 delivers the script it snatched to the script executing module 207 so as to have the script executed (Step S40). As a result of the execution of the script, the data in the form is transmitted from the data transmitting module 211.

When, on the other hand, the user selection module 206 determines that the button that the user operates is not the “YES” button 501 (Step S39: No), the user selection module 206 issues a directive for abandoning the snatched script to the script interpreter 205.

As described above, when the data that the user puts into a form is not encrypted and is transmitted in clear text, the user can recognize that the data is transmitted without being encrypted as the selection window 500 for asking the user if the data is to be transmitted or not is displayed. Thus, the user is required only to tell that the data is to be transmitted in clear text.

The way of displaying information for transmitting data is not standardized for reproduction apparatus for reproducing discs of the next generation. Additionally, a content holder may not authorize to display a message on the screen for displaying content. However, whenever appropriate, this embodiment can notify the user of the fact that the data put into a form can be transmitted in clear text, regarding the authority of the content holder, by displaying the selection window 500 in a region different from the region where the content window 300 is displayed.

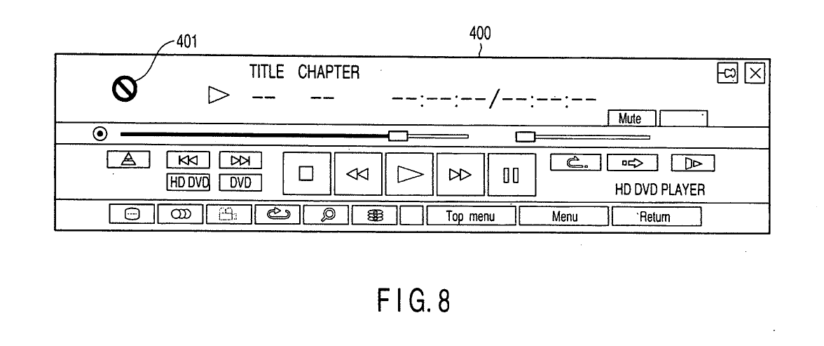

When the data put into a form is transmitted in clear text, a mark 401 indicating that the data is to be transmitted in clear text may be displayed in the control window 400 as shown in FIG. 8.

While the embodiment is described above in terms of an apparatus for reproducing HD DVDs, a selection window may also be displayed in an apparatus for reproducing a Blue-ray disc so as to allow the user to check if the data is to be transmitted in clear text without being encrypted or not. The selection window is displayed in a region different from the region where the content window is displayed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc reproduction apparatus for reproducing an optical disc storing information including content, the apparatus comprising:
a content reproducing module configured to display the reproducing image of the content on a display;
a transmission determining module configured to determine if the data put into a data input form in the reproducing image of the content by the user is to be transmitted to a server by way of a network or not;
a protocol determining module configured to determine if the data is to be transmitted in clear text or not when the data is determined to be transmitted to the server;
a selection result detection module configured to detect the result of the user's selection of transmitting the data to the server or not when the protocol determining module determines that the data is to be transmitted in clear text; and
a transmitting module configured to transmit the data to the server when the user's selection is in favor of transmission.

2. The apparatus of claim 1, wherein
the selection result detection module displays a selection window containing a button for asking the user to select transmission or non-transmission on the display.

3. The apparatus of claim 2, wherein
the content reproducing module has a window mode for displaying the reproduced image in the video window in the display; and
the selection result detection module displays the selection window in a region different from the region of the video window.

4. The apparatus of claim 3, wherein
the content reproducing module further includes a full screen mode for displaying the reproduced image of the content on the display; and
the selection result detection module issues a directive for switching to the video window mode to the content reproducing means when the content reproducing means is displaying the reproduced image of the content in the full screen mode.

5. The apparatus of claim 1, further comprising:
a displaying module configured to display a message telling that the data is to be transmitted in clear text when the data is to be transmitted so.

6. A method of controlling an optical disc reproduction apparatus for reproducing an optical disc storing information including content, the method comprising:
displaying the reproducing image of the content on a display;
determining if the data put into a data input form in the reproducing image of the content by the user is to be transmitted to a server by way of a network or not;
determining if the data is to be transmitted in clear text or not when the data is determined to be transmitted to the server;
displaying a selection window containing a button for asking the user to select transmission or non-transmission of the data on the display when the data is determined to be transmitted in clear text; and
transmitting the data to the server when the user selects transmission; and
not transmitting the data to the server when the user selects non-transmission.

7. The method of claim 6, wherein
the optical disc reproduction apparatus further has a window mode for displaying the reproduced image in the video window in the display; and
the selection window is displayed in a region different from the region of the video window.

8. The method according to claim 7, wherein
the optical disc reproduction apparatus further has a full screen mode for displaying the reproduced image of the content on the display in full screen; and
the selection window is displayed after switching to the window mode when the full screen mode is in effect.

9. The method of any one of claim 6, wherein
a message telling that the data is to be transmitted in clear text is displayed when the data is to be transmitted so.
